(19) United States
(12) Patent Application Publication
(10) Pub. No.: US 2015/0110529 A1
(43) Pub. Date: Apr. 23, 2015

(54) FUSER FOR UNIFORMING TEMPERATURE OF HEATING DEVICE

(71) Applicants: TOSHIBA TEC KABUSHIKI KAISHA, Tokyo (JP); KABUSHIKI KAISHA TOSHIBA, Tokyo (JP)

(72) Inventors: Toshihiro Sone, Kanagawa-ken (JP); Kazuhiko Kikuchi, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 14/056,332

(22) Filed: Oct. 17, 2013

(51) Int. Cl. G03G 15/20

(52) U.S. Cl. CPC G03G 15/2042
USPC 399/328

(57) ABSTRACT

A fuser comprises an endless heating device having a heat transport device and a heat generation layer closely contacted with the heat transport device, an induction current generation device configured to heat the heating device through electromagnetic induction and a pressurization device forming a nip with the heating device.

### FIELD

Embodiments described herein relate to a fuser used in an image forming apparatus and to a fuser obtaining the temperature uniformity of a heating device.

### BACKGROUND

A fuser is known which contacts or separates an auxiliary heating device provided with a heat pipe with or from a fixing belt in an area opposite to an IH coil in order to achieve the temperature uniformity of a fixing member, a fixing and heating member or a thin film heating belt capable of heating instantly (hereinafter referred to as a fixing belt). Alternatively, another fuser is also available which is provided with a plurality of coils different in the length of IH coils that generate magnetic flux in a fixing belt and switches the plurality of coils according to the width of a sheet to be fixed.

However, the auxiliary heating device does not uniformly heat the whole circumferential surface of the fixing belt at the same time, and only the area of the fixing belt contacted with the auxiliary heating device is uniformly heated by a heat pipe. The fixing belt cannot be fully heated uniformly in the case which the area uniformly heated by the heat pipe is limited, and it may occur insufficiency of fixing quantity of heat, or overheating, temperature unevenness and the like. Or the IH coil is not provided with coils of different lengths corresponding to widths of various sheets and papers fed through a device, and the heating of the IH coil for an area on a sheet different from an area where paper is fed through a device may bring about the abnormal heating of the fixing belt.

### BRIEF DESCRIPTION OF THE DRAWINGS

FIG. 1 is a schematic configuration diagram illustrating an MFP carrying the fuser described in an embodiment;

FIG. 2 is a schematic configuration diagram illustrating the fuser which comprises the control block described in the embodiment when observed from a lateral side;

FIG. 3 is a schematic configuration diagram illustrating the fuser observed from a front side according to the embodiment;

FIG. 4 is a schematic configuration diagram illustrating a heat roller observed from a lateral side according to a modification 1; and

FIG. 5 is a schematic configuration diagram illustrating a heat roller observed from a lateral side according to a modification 2.

### DETAILED DESCRIPTION

In accordance with an embodiment, a fuser comprises an endless heating device having a heat transport device and a heat generation layer closely contacted with the heat transport device, an induction current generation device configured to heat the heating device through electromagnetic induction and a pressurization device forming a nip with the heating device.

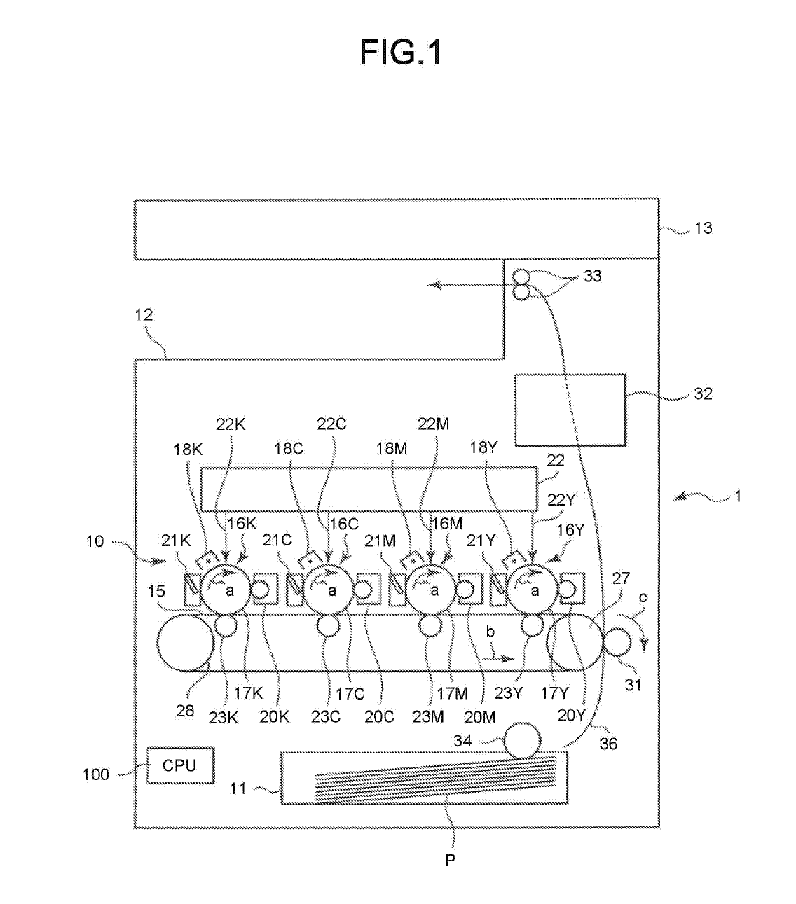

An embodiment is described below. FIG. 1 is a schematic configuration diagram illustrating a color MFP (Multi Functional Peripheral) 1 serving as an image forming apparatus in a tandem form which carries the fuser of the embodiment. The MFP 1 comprises a printer device 10 serving as an image forming device, a paper feeding device 11, a paper discharging device 12 and a scanner 13. The MFP 1 comprises a CPU 100 for controlling the whole MFP 1.

The printer device 10 comprises Y (Yellow), M (Magenta), C (Cyan) and K (black) four image forming stations 16Y, 16M, 16C and 16K which are arranged in parallel along an intermediate transfer belt 15. The image forming stations 16Y, 16M, 16C and 16K are provided with photoconductive drums 17Y, 17M, 17C and 17K, respectively.

The image forming stations 16Y, 16M, 16C and 16K are respectively provided with chargers 18Y, 18M, 18C and 18K, developing apparatus 20Y, 20M, 20C and 20K and photoconductor cleaners 21Y, 21M, 21C and 21K around the photoconductive drums 17Y, 17M, 17C and 17K rotating in the arrow a direction. The printer device 10 comprises a laser exposure device 22 constituting an image forming unit. The laser exposure device 22 irradiates the photoconductive drums 17Y, 17M, 17C and 17K with laser beams 22Y, 22M, 22C and 22K corresponding to different colors. The laser exposure device 22 radiates laser beams to form electrostatic latent images on each of photoconductive drums 17Y, 17M, 17C and 17K.

The printer device 10 comprises a backup roller 27 for supporting the intermediate transfer belt 15 and a driven roller 28 and moves the intermediate transfer belt 15 travel in the arrow b direction. The printer device 10 is provide with primary transfer rollers 23Y, 23M, 23C and 23K at positions which are respectively opposite to the photoconductive drums 17Y, 17M, 17C and 17K across the intermediate transfer belt 15. The primary transfer rollers 23Y, 23M, 23C and 23K primarily transfer the toner images formed on the photoconductive drums 17Y, 17M, 17C and 17K to the intermediate transfer belt 15 and superimpose the toner images in sequence. The photoconductor cleaners 21Y, 21M, 21C and 21K clean the toner left on the photoconductive drums 17Y, 17M, 17C and 17K after the primary transfer.

The printer device 10 comprises a secondary transfer roller 31 at a position opposite to the back-up roller 27 across the intermediate transfer belt 15. The secondary transfer roller 31 is driven by the intermediate transfer belt 15 to rotate in the arrow c direction. The printer device 10 picks up a sheet P serving as a recording medium from the paper feeding device 11 with a pickup roller 34 and feeds, matching with the timing which the toner images on the intermediate transfer belt 15 reach the second transfer roller 31, feeds the sheet P to the secondary transfer roller 31 along a conveyance path 36. During the secondary transfer, the printer device 10 forms a transfer bias on the nips between the intermediate transfer belt 15 and the second transfer roller 31 and secondarily transfers the toner images on the intermediate transfer belt 15 to the sheet P all together.

The printer device 10 is provided with a fuser 32 serving as a fuser and a paper discharging roller pair 33 at the downstream of the secondary transfer roller 31 along the conveyance path 36.

If a printing is started, the MFP 1 transfers an image formed by the printer device 10 to a sheet P and discharges the sheet to the paper discharging device 12 after fixing.

The image forming apparatus is not limited to be in a tandem form, and the number of the developing apparatus is not limited either. The image forming apparatus may also transfer a toner image directly from a photoconductor to a recording medium.

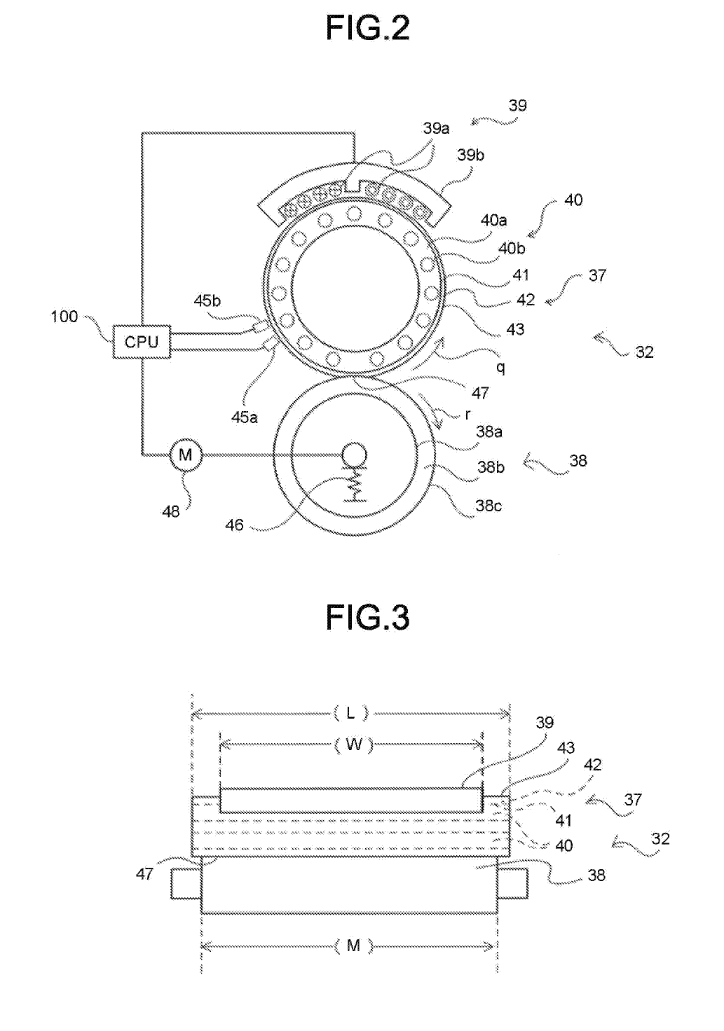

The fuser 32 will be described later. As shown in FIG. 2 and FIG. 3, the fuser 32 comprises a heat roller 37 serving as a heating device, a press roller 38 arranged opposite to the heat roller 37 and serving as a pressurization device and an induction current generator coil (hereinafter referred to as IH coil for short) 39 serving as an induction current generation device. The fuser 32 comprises a thermistor 45a for detecting the temperature of the heat roller 37 and a thermostat 45b serving as a safety device for detecting the abnormal heating of the fuser 32. The CPU 100 controls the output of the IH coil unit 39 according to the detection result of the thermistor 45a. When the thermostat 45b is powered off, the CPU 100 cuts off the power supply to the IH coil unit 39.

The heat roller 37 comprises such as a heat pipe unit 40 serving as a heat transport device. The heat roller 37 comprises a conductive layer 41 serving as a heat generation layer closely contacted around the circumferential surface of the heat pipe unit 40. The heat roller 37 is provided with, for example, an elastic layer 42 and a release layer 43 around the conductive layer 41.

The conductive layer 41 made of, for example, Fe, is inductively heated by the magnetic field from the IH coil unit 39. The conductive layer 41 may also be made from Ni, Cu, Ag, Sus and other materials, so long as they can be inductively heated by a magnetic field or is formed into a multilayer structure by laminating different magnetic components. The conductive layer 41 is closely contacted with the heat pipe unit through vapor deposition, electrodeposition, electroplating, electrocasting and pressure welding.

A plurality of heat pipes 40b are arranged at equal intervals in the thick wall of, for example, the hollow roller 40a made of Cu, serving as a hollow pipe of the heat pipe unit 40. The hollow roller 40a, although made of Cu in the embodiment, may be made of cheaper aluminum or high-strength stainless steel instead of Cu. The heat pipe 40b is formed by molding a hollow part in the hollow roller 40a with a drawing, filling the hollow part with a solvent such as water and then sealing the hollow part. The hollow part may form the hollow roller 40a through the extrusion molding.

The length of the heat pipe 40b is equal to, for example, the length (L) of the heat roller 37. When a temperature difference occurs in the longitudinal direction of the heat pipe 40b, the steam in the heat pipe 40b fast convects from a high temperature part to a low temperature part. The heat pipe 40b fast transports the heat of the high temperature part to the low temperature part to uniform the temperature in the longitudinal direction. The heat pipe 40b has a higher thermal conductivity than Cu.

The temperature difference generated by the heat roller 37 in the longitudinal direction is transferred to the heat pipe unit 40. The heat pipe 40b transports the temperature of the thermally conducted high temperature part thermally to the low temperature part to uniform the temperature of the heat roller 37.

The elastic layer 42 includes, for example, silicone rubber for improving the fixation property of the fuser 32. The release layer 43 is made from, for example, PFA resin.

The press roller 38 has an elastic layer 38b with a heat insulation including silicone rubber or silicone sponge on the surface of, for example, a core bar 38a. The press roller 38 has a release layer 38c including fluorine resin such as PFA resin on the surface of the elastic layer 38b. The press roller 38 is formed into have a length (M) slightly less than that of the heat pipe 40b.

During the process of a fixation operation, the press roller 38 presses the heat roller 37 with a press unit 46 driven by the CPU 100 to forma nip 47 between the heat roller 37 and the press roller 38. The press roller 38 rotates in the arrow r direction under the drive of a motor 48 controlled by the CPU 100. The heat roller 37 is driven by, for example, the press roller 38 to rotate in the arrow q direction. The heat roller 37 may also rotate independently of the press roller 38.

The IH coil unit 39 comprises a single coil 39a for generating magnetic flux and a core 39b for concentrating the magnetic flux generated by the coil 39a towards the direction of the conductive layer 41. The coil 39a is formed by coiling litz wire which bundles a plurality of copper wire materials coated with heat-resistant polyamide-imide serving as an insulation material. For example, the length in the longitudinal direction of the coil 39a is equal to the maximum width (W) of a sheet P that can be printed by the MFP 1.

The operation of the fuser 32 will be described later.

According to the warming-up start of the MFP 1, the CPU 100 drives the press unit 46, the motor 48 and the IH coil unit 39. The press unit 46 presses the press roller 38 to the heat roller 37 to form the nip 47 between the heat roller 37 and the press roller 38. The motor 48 rotates the press roller 38 in the arrow r direction and enables the heat roller 37 to rotation-drive in the arrow q direction. The CPU 100 controls the ‘on/off’ of the single coil 39a of the IH coil unit 39 according to the temperature of the heat roller 37 detected by the thermistor 45a. The IH coil unit 39 generates magnetic flux in the area of the (W) of the heat roller 37 to enable the conductive layer 41 to generate heat. The heat unit 40 transports the heat generated by the conductive layer 41 in the area (W) to the whole length (L) in the longitudinal direction of the heat roller 37 to uniform the heat of the heat roller 37.

The heat roller 37 takes heat by contacting with the press roller 38 after reaching the position of the nip 47. The heat roller 37 generates, inside the nip 47, a temperature difference in the longitudinal direction of the part contacted with the press roller 38 and the part not contacted with the press roller. The heat pipe unit 40 in which heat pipes 40b are built-in at equal intervals eliminates, in the nip 47, the temperature difference generated by the heat roller 37 in the longitudinal direction to uniform the temperature of the heat roller 37.

If there is a temperature difference in the heat roller 37, the heat pipe 40b immediately convects steam from the high temperature are to the low temperature area to uniform the temperature of the heat roller 37. The temperature of the heat roller 37 is uniformed, and the press roller 38 contacted with the heat roller 37 in pressure quickens the rise of temperature to shorten warming-up time.

Started in the printing of MFP1, the CPU 100 controls the ‘on/off’ of the coil 39a of the IH coil unit 39 according to the detection result of the thermistor 45a to keep the temperature of the heat roller 37 at a fixing temperature. The MFP 1 conveys the sheet P on which an image is formed by the printer device 10 to the nip 47 of the fuser 32. The fuser 32 heats and presses the sheet P to fix the image on the sheet P. During a fixation process, the IH coil unit 39 inductively heats the heat roller 37 in the maximum width (W) area of the sheet P using the single coil 39a, regardless of the width of the sheet P. The heat generating area of the heat roller 37 is likely to be set as the maximum width (W) of the sheet P.

The sheet P passing through the nip 47 takes heat of the heat roller 37 and the press roller 38. When the width of the sheet P passing through the nip 47 is less than the maximum width (W), the heat roller 37 and the press roller 38 generate a temperature difference in the longitudinal directions thereof in an area where a sheet P is fed through a device and an area where no sheet P is fed through a device.

The heat pipe unit 40 in which heat pipe 40b are built-in at equal intervals in the hollow roller 40a uniforms the temperature of the heat roller 37 on the whole circumferential surface. The heat pipe unit 40 uniforms the temperature of the heat roller 37 at the position of the nip 47.

The heat pipe 40b transports, at the position of the nip 47, the heat in the area of the heat roller 37 where no paper is fed through a device to the area where paper is fed through a device so as to uniform the temperature of the heat roller 37. The heat pipe 40b transports the heat in the area where no paper is fed through a device to the area where paper is fed through a device. The heat pipe 40b replenishes the heat to the area of the heat roller 37 where paper is fed through a device to prevent the interruption of a printing mode caused by the insufficiency of temperature in the area of the heat roller 37 where paper is fed through a device.

The heat pipe 40b takes the heat of the area of the heat roller 37 where no paper is fed through a device to eliminate the temperature distribution unevenness of the heat roller 37. In the following fixation for a wide sheet P by the fuser 32, the heat pipe 40b prevents the occurrence of a fixing failure caused by the temperature distribution unevenness of the heat roller 37. Moreover, the heat pipe 40b prevents the interruption of a printing mode caused by the overheating of the area of the heat roller 37 where no paper is fed through a device. By uniforming the temperature of the heat roller 37 with the heat pipe 40b, the temperature of the press roller 38 contacted with the heat roller 37 in pressure is uniformed. The fuser 32 relieves the temperature distribution unevenness in the nip 47 caused by the feeding of the sheet P, thereby achieving an excellent fixation performance.

When the fuser 32 continuously feeds narrow small sheet P quickly, the heat pipe 40b effectively uniforms the temperature difference existing between an area where paper is fed through a device and an area where no paper is fed through a device in the nip 47. The temperature distribution unevenness in the nip 47 in the fuser 32 is relieved, thus achieving an excellent fixation performance. The fuser 32 prevents the interruption of a print mode caused by the insufficient temperature in an area where paper is fed through a device or by the overheating of an area where no paper is fed through a device, thereby improving the productivity of the MFP 1.

According to the embodiment, the heat roller 37 of the fuser 32 is provided with a heat pipe unit 40 in which a plurality of heat pipes 40b are arranged at equal intervals and a conductive layer 41 closely contacted with the heat pipe unit 40. The IH coil unit 39 of the fuser 32 enables the heat roller 37 to generate heat with a single coil 39a. The heat pipe 40b transports the temperature of the high temperature part in the longitudinal direction of the heat roller 37 to a low temperature part to uniform the temperature of the heat roller 37. The heat pipe unit 40 can uniform the temperate of the heat roller 37 at the position of the nip 47, thereby unifying the temperature of the press roller 38 which is contacted with the heat roller 37 in pressure.

In accordance with the embodiment, the fuser 32 uniforms the temperature of the heat roller 37 and the press roller 38 with the heat pipe unit 40 to shorten warming-up time. The fuser 32 uniforms the temperature of the heat roller 37 and the press roller 38 to eliminate the temperature distribution unevenness, thereby acquiring an excellent fixing. The fuser 32 uniforms the temperature of the heat roller 37 and the press roller 38 to prevent the interruption of a print mode caused by insufficient temperature or overheating. As the IH coil unit 39 is a single coil 39a, the fuser 32 can simplify the control over the IH coil unit 39.

In the embodiment, no limitation is given to the fuser, for example, the facing device forming a nip with the heating device may also be a pad member which is contacted with the heating device in pressure. For example, the pad member has a heat-resistant elastic layer made from aluminum (Al) or another coated metal. Moreover, the pad member may also be made from heat-resistant Polyetheretherketone (PEEK) resin, Phenol-formaldehyde (PF) resin and the like. In a case where the facing device is a pad member, the friction resistance between the heating device and the facing device can be reduced by interposing a low-friction sheet with good sliding property and excellent wear resistance between the heating device and the facing device.

The fuser may further closely contact with a heating layer in the internal circumferential surface of the heat transport device and have an induction current generation device in the endless heating device. The induction current generation device of the fuser may have a plurality of coils.

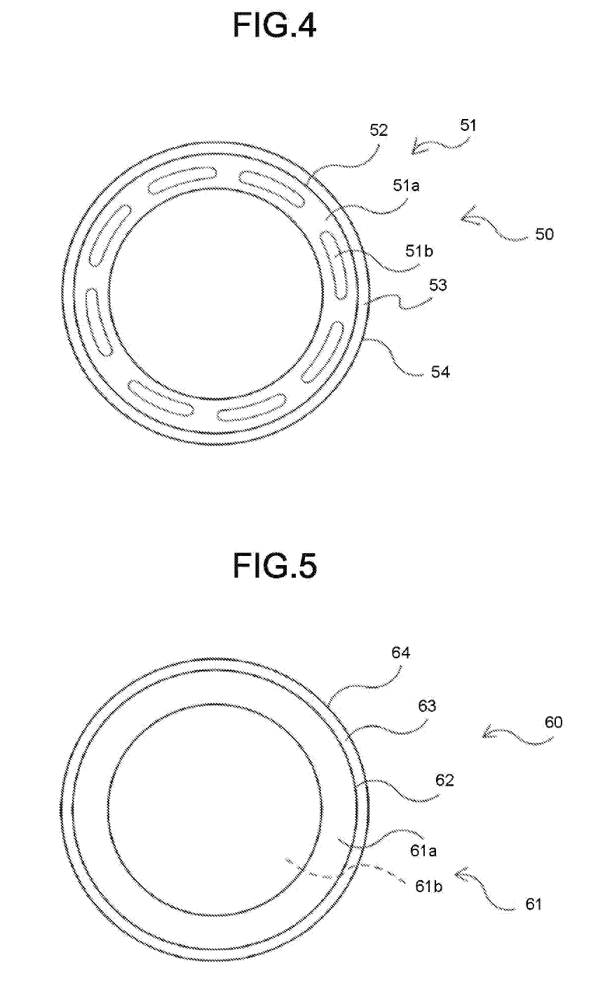

No limitation is given to the configuration of the heating device. The heating device may be a heat roller 50 according to the modification 1 shown in FIG. 4. A plurality of heat pipes 51b having an oval cross section are comprised at equal intervals in the thick wall of the hollow roller 51a of the heat pipe unit 51 of the heat roller 50. A conductive layer 52 is closely contacted with the outer circumferential surface of the heat pipe unit 51 of the heat roller 50, and an elastic layer 53 and a release layer 54 are comprised around the conductive layer 52.

The heating device may also be a heat roller 60 according to the modification 2 shown in FIG. 5. The heat transport device of the heat roller 60 is a single heat pipe 61 having a sealed hollow pipe 61a filled with a solvent 61b. A conductive layer 62 is closely contacted with the outer circumferential surface of the heat pipe 61 of the heat roller 60, and an elastic layer 63 and a release layer 64 are comprised around the conductive layer 62.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. A fuser, comprising:
a heating device provided with a heat transport device and a heat generation layer closely contacted around the circumferential surface of the heat transport device, wherein the heat transport device is a hollow pipe having a plurality of heat pipes in a thick wall thereof;
an induction current generation device configured to heat the heat generation layer through electromagnetic induction; and
a pressurization device which forms a nip with the heating device.

2. (canceled)

3. The fuser according to claim 1, wherein the plurality of heat pipes are arranged in the thick wall of the hollow pipe at equal intervals.

4. The fuser according to claim 1, wherein a thermal conductivity of the heat pipe is higher than that of the material of the hollow pipe.

5. The fuser according to claim 1, wherein the induction current generation device has a single coil opposite to the heating device.

6. An image forming apparatus, comprising:
an image forming device configured to form an image on a recording medium;
a heating device provided with a heat transport device and a heat generation layer closely contacted around the circumferential surface of the heat transport device and contacted with the recording medium on which an image is formed, wherein the heat transport device is a hollow pipe having a plurality of heat pipes in a thick wall thereof;
an induction current generation device configured to heat the heat generation layer through electromagnetic induction; and
a pressurization device which forms a nip with the heating device.

7. (canceled)

8. The apparatus according to claim 6, wherein the plurality of heat pipes are arranged in the thick wall of the hollow pipe at equal intervals.

9. The apparatus according to claim 6, wherein a thermal conductivity of the heat pipe is higher than that of the material of the hollow pipe.

10. The apparatus according to claim 6, wherein the induction current generation device has a single coil opposite to the heating device.
